(19) United States
(12) Patent Application Publication
(10) Pub. No.: US 2004/0148201 A1
(43) Pub. Date: Jul. 29, 2004

(54) Insurance management system

(76) Inventors: Tracy Lee Smith, Tampa, FL (US); Hailey Ann Stefan, Tampa, FL (US); Claude Cloutier, Riverview, FL (US); Celio Couto, Brandon, FL (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/352,268

(22) Filed: Jan. 27, 2003

(51) Int. Cl. G06F 17/60

(52) U.S. Cl. 705/4

(57) ABSTRACT

The invention is an insurance management system and method that can be used to give insurance agents more control over the policies that they sell and/or administer. The system allows agents and other entities to access and manipulate information in accordance with the “intelligence” of insurance experts that is flexibly embedded into the system in the form of automated business rules. An input subsystem can be used to enter, modify, select, and delete data on the system. A policy subsystem can be used to add, update, and delete data relating to insurance contracts, such as reusable template endorsements. A quote subsystem can be used to generate, update, and delete financial data relating to a particular insurance contract or provision.

### BACKGROUND OF INVENTION

The present invention relates in general to systems and methods for managing insurance contracts. In particular, the present invention relates to a comprehensive insurance management system and method (collectively “system”) for integrating the activities and communications of relevant entities in a comprehensive manner, subject to automatically enforced pre-defined business rules that incorporate the knowledge and experience of insurance industry experts.

Insurance transactions are typically more complex than typical two-party transactions. A single insurance policy can involve a potentially voluminous number of different entities and organizations. Insurance carriers, underwriters, government regulatory agencies, brokers, agents, administrators, and insured entities and persons (collectively “relevant entities”), can each have significant input into the substance of an insurance policy. Moreover, many relevant entities can interact with an insurance policy after it is created and potentially trigger the modification of such policies. It would be desirable for a system to facilitate communication between such entities in a timely and integrated manner.

The administration of insurance contracts typically requires highly specialized insurance expertise that is often embodied in a relatively small number of key employees. However, the implementation and application of that expertise is only indirectly incorporated into the management of insurance contracts through a sometimes voluminous number of administrative tasks performed by persons with substantially less expertise. Few tasks involve purely the application of expertise and similarly few tasks involve solely administrative characteristics. It would be desirable for an insurance management system to facilitate the creation and enforcement of business rules incorporating the business expertise of insurance experts. It would also be desirable for a system to automatically apply and enforce the “intelligence” of the system in relation to administrative tasks to be performed by employees and other persons without significant insurance expertise. The performance of low-expertise administrative tasks could then be automatically shaped, configured, and triggered in accordance with expertise embodied in the pre-defined business rules. It may be desirable for an insurance management system to interface with existing legacy components in order to maximize the availability of data, minimize the costs of implementing the system, and avoid the need to “reinvent the wheel.”

Insurance agents, whether they are employees of the underwriter or independent contractors, need to interact with underwriters, insurance carriers (“carriers”), and other types of relevant entities. The need for insurance agents to “check back” with some other relevant entity slows down the ability of those relevant entities to conduct business, and often introduces errors and inaccuracies into the process, as those entities engage in an unintentional game of “telegraph.” It would be desirable to empower agents and other appropriate persons with an insurance management system that provides them better control and information relating to policies involving that agent. Prior art systems do not provide agents with such abilities. At least in part, such limitations on the activities of insurance agents and other persons and entities is the result of a need for insurance carriers, underwriters, and other relevant entities to control what is happening further downstream. It would be desirable for underwriters, carriers, and other entities to control their relevant process of insurance administration. It would be desirable if such a need for control could be satisfied by a system that supports and enforces flexibly set business protocols of the various relevant entities. However, the prior art known to the inventors not only fails to suggest or motivate such a solution, but in fact teaches away from such a system.

### SUMMARY OF INVENTION

The invention is an insurance management system and method (collectively, the “system”).

The system can be used to give insurance agents more control over the policies that they sell and/or administer, because other relevant entities such as underwriters and carriers can preclude inappropriate activities by business rules or protocols (collectively, “business rules”) that are automatically enforced by the system.

The system can allow agents and other appropriate entities to access and manipulate information in accordance with the “intelligence” of insurance expertise that is flexibly embedded into the system in the form of automated business rules and protocols.

All sorts of different relevant entities such as agents, brokers, insurance carriers (“carriers”), underwriters, insured entities, government entities, administrators, advisory boards, and other entities (collectively, “relevant entities”) can use the system to directly interact with each other in a timely, integrated, comprehensive, and sometimes automated manner.

With the correct input, the system can automatically create a quote for a new or existing insured entity such as a person or business. A proposal can be automatically created from such a quote. Standard and customized contract provisions can be applied to or removed from existing insurance contracts. New business rules and contract provisions can be submitted to underwriting for approval if the business rules do not permit an agent to act unilaterally. So long as they are consistent with the business rules embedded in the system, insurance contracts and lists of approved standard contract provisions can be printed out in full. The system can also be used to satisfy inquiries relating to existing policies, and to generate sophisticated reusable and one-time only reports, in both standardized and customized formats. Marketing information not typically available to the public can also be incorporated into the system.

The system can include an input subsystem for capturing an input characteristic that can be used to generate a policy characteristic. A policy subsystem can be used to create or amend insurance policies using one or more policy characteristics. A quote subsystem can automatically create quotes based on one or more policy characteristics of an insurance policy.

Sets of configurable business rules and protocols (collectively, “business rules” or “rules”) can be used to maximize the ability of various relevant entities to create, modify, and delete information and characteristics relating to insurance policies. The system can be used to create, modify, delete, and enforce such rules.

The system can include a wide variety of modules, such as an endorsement processing module, a rating module, a policy inquiry module, a reports module, a quote module, an administrative module, a new business module, an underwriting template module, a marketing module, a printing module, an instant messaging module, a renewals module, and/or a claims processing module.

The system can interface with one or more existing legacy computer systems components (collectively, “legacy components”) to maximize the availability of data, and minimize the costs associated with implementing the system.

Various aspects of the invention will become apparent to those skilled in the art from the following detailed description of the preferred embodiment and the drawings described briefly below.

### BRIEF DESCRIPTION OF THE DRAWINGS

FIG. 1 is a block diagram illustrating an example of an insurance management system, including some examples of system components that can be used by the system and types of data that can be processed by the system.

FIG. 2 is an entity-relationship diagram illustrating some examples of the different types of entities and organizations that can be relevant to insurance relationships.

FIG. 3 is a entity-relationship diagram illustrating an example of different relevant entities interacting with each other and various policy characteristics, subject to the constraints of the business rules.

FIG. 4 is a process-flow diagram illustrating one example of a subsystem-level view of the system.

FIG. 5 is a process-flow diagram illustrating a different example of a subsystem-level view of the system.

FIG. 6 is a block diagram illustrating examples of some of the different types of information that can be processed by the system.

FIG. 7 is a data hierarchy diagram illustrating one example of some of the different characteristics relating to insurance policies.

FIG. 8 is a block diagram illustrating one example of some of the various modules that can be incorporated into the system.

FIG. 9 is a data-relationship diagram illustrating one example of a data design that uses data collection, data collection definition, and data item tables to support the ability to interface with legacy components.

FIG. 10 is a flow chart illustrating an example of pre-defined endorsements being used to create or modify an insurance policy.

FIG. 11 is a flow chart illustrating an example of a process involving the creation and application of pre-defined business rules.

FIG. 12 is a flow chart illustrating one example of an insurance policy being created or amended in an embodiment that includes a legacy component.

FIG. 13 is a flow chart illustrating one example of an endorsement request being submitted by an agent to an underwriter through the system.

FIG. 14 is a flow chart illustrating one example of an endorsement being submitted by an agent to the system through a legacy component.

### DETAILED DESCRIPTION OF SOME EMBODIMENTS

I. Introduction and Environmental View

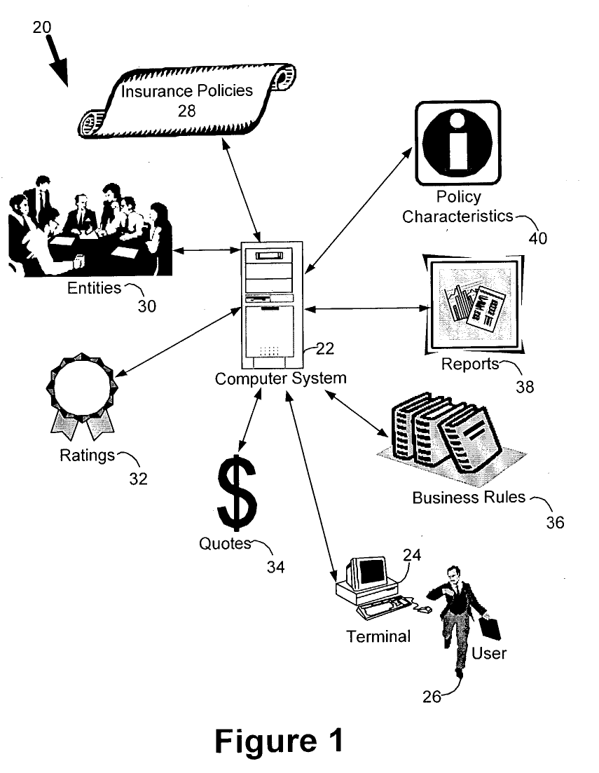

The invention is an insurance management system and method (collectively, the “system”). FIG. 1 is a block diagram illustrating an example of the system 20, including some of the components that can be incorporated into the system 20 and some of the data types that can be processed by the system 20. The system 20 can incorporate a wide variety of different components and can process a wide range of different types of data and insurance-related characteristics (collectively “insurance policy characteristics” or “policy characteristics”).

A. Computer System

A computer system 22 can be any device or devices capable of housing and performing the logic necessary for performing the functionality of the system 20. In many embodiments, the computer system 22 is a server computer that is accessible by many client devices. However, the computer system 22 can incorporate a voluminous number of different alternative embodiments. Stand-alone computers, network servers, networks, intranets, extranets, the Internet, grid computers, mainframe computers, work stations, personal computers, laptop computers, personal data or digital assistants (PDAs), cell phones, programmable logic devices, embedded computers, satellite pagers, and any other device (including peripherals) capable of running a computer program can be part of the computer system 22. The computer system 22 can interface with, or even include, one or more legacy components. Legacy components are one or more information technology systems used to by users in the insurance industry to store and process information. Thus, the system 20 can be placed over existing information technology architectures.

B. Terminal

A user 26 accesses the computer system 22 through a terminal 24. The terminal 24 can be any device capable of interacting with the computer system 22. In some embodiments, the terminal 24 is the same device as the computer system 22. In a preferred embodiment, the terminal 24 is not the same device as the computer system 22, and there are many different types of terminals 24 that can interact with the computer system 22. The terminal 24 can be a “dumb” terminal, personal computer, cell phone, personal data or digital assistant (PDA), satellite pager, work station, personal computer, laptop computer, or any other device capable of interfacing with the computer system 22. In a preferred embodiment, numerous terminals 24 of different types can interact with the computer system 22 and the system 20 at the same time. The terminal 24 interacts with the computer system 22 through an interface. In a preferred embodiment, the interface is a web browser or similar graphical interface. Different types of interfaces can be used by a single embodiment of the system 20.

C. Users

A user 26 is typically a human being that has a relationship or affiliation with a company, organization, or some entity 30. Users 26 can include any person or entity 30 that can potentially play some role with respect to an insurance contact. Users 26 need not be limited to human beings. Computer systems 22 that incorporate artificial intelligence, expert systems, neural networks, and other intelligence technologies (collectively “intelligence technologies”) can also be users 26. Users 26 can also be computer programs that do not incorporate any form of intelligence technology, such as routine report programs, search engines and agents, or any other function which might find access to policy characteristics 40 to be helpful or useful. The system 20 can incorporate a wide variety of different types of users 26, both human beings and technological devices.

D. Insurance Policies and Policy Characteristics

The system 20 can process any information that is potentially relevant to the management of insurance contracts (“insurance policies” or “policies”) 28. Unlike typical contracts in other contexts, an insurance contract 28 typically involves more than simply two parties. As discussed below, a wide range of different entities such as insurance carriers (“carriers”), insurance underwriters (“underwriters”), government entities (“government”), insurance brokers (“brokers”), advisory boards, insured persons and entities (“insureds”), administrators, insurance agents (“agents”), and any other potentially relevant entity (collectively, “relevant entity”) may have characteristics based on the specific entity or type of entity that is relevant for processing purposes.

An insurance policy 28 can have a wide range and variety of different policy characteristics. Policies 28 can have a wide variety of relevant attributes, such as an entity 30 characteristic, a rating 32 characteristic, a quote 34 characteristic, standardized and customized endorsements, non-coverage provisions, and any other data that potentially relates to the policy 28 (collectively, “policy information” or “policy characteristics” 40). Policy characteristics 40 are described in greater detail below.

Some policies 28 are made up of several potentially distinct policies 28. Such policies can be referred to as “package policies” or “integrated policies” For example, a package policy for a particular insured could include professional malpractice coverage, general liability coverage, and property and casualty insurance.

E. Reports

The system 20 can be used to generate a wide variety of different reports 38. Different entities 30 accessing the system 20 can generate different types of customized and standard reports 38. Reports 38 can be generated for a wide variety of different purposes. For example, certain reports 38 can be useful for potential purchasers of a policy 28. Other types of reports 38 can include formal documentation required by government entities. The types and variety of reports 38 are at least in part, impacted by a number of business rules 36 created and maintained by the system 20. For example, binders and certificates of insurance (collectively, “certificates”) can be generated as reports by the system 20.

F. Business Rules

The system 20 can incorporate the “intelligence” of insurance expertise in the form of highly configurable business rules and protocols (collectively, “business rules” or simply the “rules”) 36 that can be automatically enforced by the system 20. Expert systems, artificial intelligence, neural networks, and other intelligence technologies (collectively “intelligence technologies”) can be incorporated into the system 20 and the rules 36 applied by the system 20. Intelligence technologies. In some embodiments, the intelligence technologies can be used to create the rules 36 applied by the system 20. In other embodiments, intelligence technologies are used to apply and enforce the rules 36 embedded into the system 20 by human beings.

By embedding “intelligence” into the system 20, insurance expertise can automatically be applied to the actions and determinations of users 26 without insurance expertise. This can reduce costs, increase accuracy, and speed up the processing of information relating to insurance policies (“policy characteristics” 40).

The framework of enforceable business rules 36 allows the system 20 to empower agents, brokers, and other persons (collectively “users” 26) and entities 30, with greater control over policy characteristics 40. Those entities 30 and users 26 can rely on the system 20 to prohibit unauthorized and inappropriate activities, such as actions that are inconsistent with the business rules 36. Consistent with the business rules 36 and intelligence technologies, a quote 34 for new or existing customers can be created automatically by the system 20. Similarly, proposals relating to quotes 34 can be generated automatically by the system 20. New policies 28 and contract provisions can be created and modified by using the system 20.

The automatically enforceable business rules 36 can differentiate between activities that require additional approvals, and activities that can be performed immediately because they are pre-approved. The business rules 36 can also trigger the system 20 to automatically invoke the appropriate approval process for those activities requiring additional affirmative approvals.

The business rules 36 can be highly configurable to fit the needs of many different relevant entities 30 in many different contexts. In a preferred embodiment, the business rules 36 are housed in a fully normalized database, so that the business rules 36 can treat policies 28 distinctly based on potentially any policy characteristics 40. The business rules 36 can be configured to make distinctions based on a single different entity characteristic, such as entity role (underwriter, carrier, government, broker, advisory board, insured, agent, or administrator), an entity identity, financial characteristics relating to the entity 30, or any other attribute relating to an entity 30. Business rules 36 can also distinguish any number of different policy characteristics 40, such ratings 32, quotes 34, users 26, reports 38, policies 28, and endorsements.

Business rules 36 may distinguish among entity characteristics or any other policy characteristic 40 in evaluating a request for increasing a liability limit. Similarly, in adding or deleting a risk management credit, the business rules 36 can look to the rating 32, the type of policy 28, or some other policy characteristic 40 in determining what is allowed and what is not allowed. A malpractice policy 28 may permit or forbid a premium reduction for a part-time practice based on the past history of the insured, the type of profession practiced by the insured, or some other policy characteristic 40. The updating of a construction code on a real estate policy 28 can be accepted or prohibited on the basis of whether the property is of a certain earthquake class or some other policy characteristic 40.

Business rules 36 can also incorporate the inputs of different entities 40. Different entities 30 can set different business rules 36. The business rules 36 of underwriters can define how underwriters wish to interact with other entities 30, such as carriers and insureds. For example, the business rules 36 of an underwriter can be configured to treat carriers differently based on the business rules 36 of a particular carrier. This can allow for better risk management, and a means to implement reciprocity with respect to certain policies and practices. Moreover, long-standing relationships and practices between entities 30 can be automatically enforced by the system 20. Thus, the system 20 can be used to facilitate the interactions of many different parties, constrained by automatically enforced business rules set by the entity or entities entitled to set such rules. This can significantly speed up the process of change implementation with respect to the management of insurance contracts.

Business rules 36 also allow the system 20 to apply insurance expertise to the activities by users 26 that may or may not possess insurance expertise. There are as many different categories of business rules as there are categories of policy characteristics 40. For example, rating business rules relate to how a rating 32 is calculated for a particular policy 28. Quote business rules relate to how a policy 28 is priced for a particular potentially insured entity 30. Endorsement business rules relate to coverage provisions (“endorsements”) of an insurance policy 28. As discussed below, there can be standardized endorsement business rules and customized endorsement business rules. Underwriting business rules relate to the underwriter of the policy 28, and the underwriter's rules relating to the particular policy 28. Carrier business rules relate to the insurance carrier of the policy 28, and the carrier's rules relating to the particular policy 28. Entities 30 can have business rules in the system 20 that relate to their particular role with respect to the policy 28, as well as rules that are independent of their role with respect to a particular policy 28. Some business rules 36 are predefined business rules, while others are defined or created by the system 20 at the time that a particular user 26 invokes a particular action.

The business rules 36 can empower a user 26 without insurance expertise (such as general office clerk) to initiate system 20 processing, utilizing insurance expertise by allowing the system 20 to apply business rules 36 in effectuating actions by the users 26.

G. Entities

Information relating to a wide variety of entities 30 can be processed by the system 20. Business rules 36 and other system 20 processing can distinguish among different entities 30 and the roles played by those entities 30. Entities can include insurance carriers (“carriers”), insurance underwriters (“underwriters”), government entities (“government”), insurance brokers (“brokers”), advisory boards, insured persons and entities, administrators, agents, and any other potentially relevant entity may have characteristics based on the specific entity or type of entity that is relevant for processing purposes.

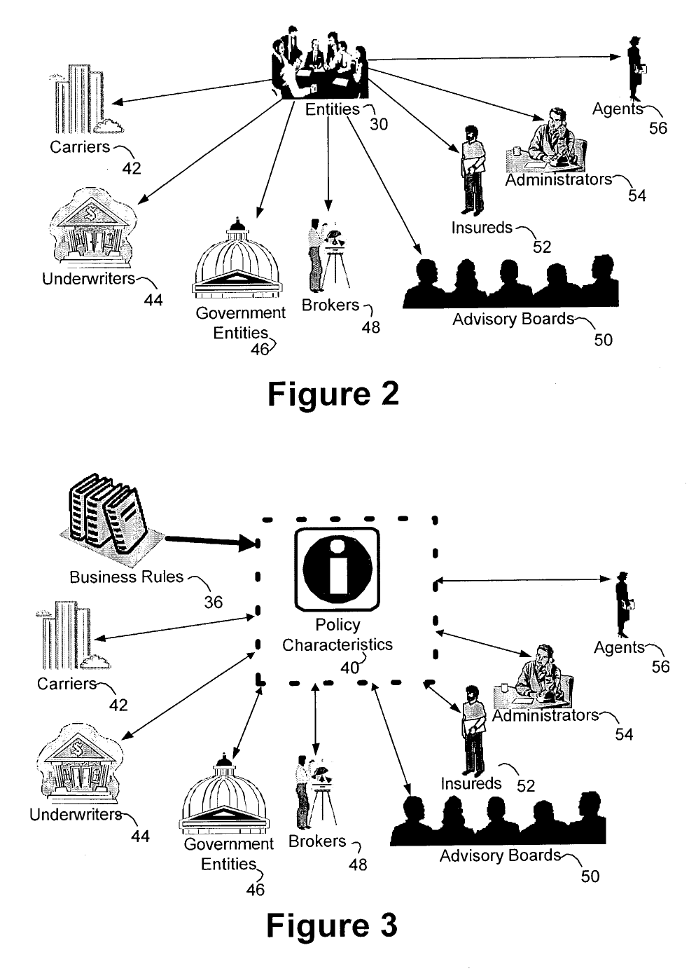

FIG. 2 is block diagram illustrating some examples of the different types of entities 30 that can be relevant to insurance relationships. Each type of entity 30 can have employees, agents, customers, suppliers, and other entity characteristics.

1. Carriers

An insurance carrier or simply carrier 42 is potentially any entity that issues an insurance policy 28. Carriers 42 are parties to the insurance contract 28 with the covered entity (whom can also be referred to as an insured 52). Carriers 42 can execute insurance contracts 28 where they themselves are the insured 52. Carriers may also perform some of the roles discussed below with respect to a particular policy 28. Each carrier 42 included in the system 20 can have business rules 36 that are specific to that particular carrier 42, as well as to a plurality of carriers 42 generally. As discussed above, package policies 28 can involve more than one carrier 42.

2. Underwriters

An underwriter 44 is potentially any entity that underwrites an insurance policy 28. Any given policy 28 can have one or more underwriters 44. Some underwriters 44 are also carriers 42. Each underwriter 44 included in the system 20 can have business rules 36 that are specific to that particular underwriter 44, as well as to underwriters 44 generally. As discussed above, package policies 28 can involve more than one underwriter 44.

3. Government Agencies and Regulatory Authorities

A government entity 46 is potentially any government entity that regulates insurance policies 28. Insurance is and can be regulated at various levels of government (e.g. federal and state levels), and thus various agencies and the like with varying roles at each level of government can interact with the system 20. Because the insurance industry is highly regulated, government entities 46 can have a significant impact on the business rules 36 enforced by the system 20. In many respects, business rules 36 may need to treat otherwise identical processes in a different manner due to differences in location/jurisdiction. Government business rules may distinguish among differences in entity roles, and other policy characteristics 40 in shaping the business rules 36 applied by the system 20.

4. Brokers

A broker 48 is potentially any entity 30 that functions at least in part, as a broker of insurance policies 48. Some brokers 48 are employees of specific underwriters 44 or carriers 42 (collectively, “employee brokers”). Other brokers 48 are independent, but have exclusive relationships with a particular underwriter 44 or carrier 42 (“independent exclusive brokers”). Still other brokers 48 have relationships with a wide variety of different carriers 42 and underwriters 44 (“independent non-exclusive carriers”). In some embodiments, a particular broker 48 can also be an agent 56, as discussed below. Broker business rules 36 can be specific to a particular broker 48, to a particular category of brokers 48, and/or can be applied to all brokers 48.

5. Advisory Boards

An advisory board 50 is potentially any assembly of persons or organizations that provide insurance expertise to an entity 30. Advisory boards 50 can work on behalf of carriers 42, underwriters 44, government agencies 46, brokers 48, or any other type of entity 30 in the system. Carriers 42, underwriters 44, government entities 46, and brokers 48 may each have one or more advisory boards. Advisory boards 50 can provide the expertise used to create, modify, and enforce the business rules 36. Advisory board business rules relate, at least in part, to the business rules of the entity with which the advisory board 50 is affiliated.

6. Insured Entity

An insured entity 52 is any person, group of persons, business, or other entity 30 that has an insured relationship with a carrier 42. An insured 52 is a party to the insurance contract 28 with the carrier 42. The status of being an insured 52 with respect to one particular policy 28 does not mean that a particular entity 30 cannot have a different classification with respect to other policies 28. Insured business rules are entity-based business rules that apply to a specific insured 52 or to a particular category or categories of insureds 52.

7. Administrator

An administrator 54 is a person responsible for administrating one or more aspects of one or more insurance policies 28 or the system 20 generally. Some carriers 42 and other entities 30 have a single administrator 54 responsible for an entire state since regulatory requirements vary from state to state. In application service provider (“ASP”) embodiments of the system 20, the administrator 54 is affiliated with the ASP entity 30. Administrator business rules 36 can be user-specific, entity-specific, jurisdiction-specific, or apply more generally.

8. Agent

An agent 56 is potentially any person or entity involved in the selling of insurance policies 28 to insured entities 52. Agents 56 can also be brokers 48, insureds 52, administrators 54, carriers 42, and direct sellers. Agent business rules can be specific to a particular agent 56, or can apply to agents 56 generally.

H. Entity Interactions and Entity Interfaces

FIG. 3 is a entity-relationship diagram illustrating an example of different relevant entities 30 interacting with each other and various policy characteristics 40, subject to the constraints of the business rules 36.

As illustrated in the diagram by the dotted box surrounding the policy characteristics 40, the business rules 36 define who can access various policy characteristics 40 and the conditions of such access. Individual fields of data can be fully accessible and updateable, with other fields being read-only and still other fields being kept from view for a particular entity 40 in a particular context given a particular business rule 36.

The various entities 30 described above interact with each other and with policy characteristics 40 by accessing the computer system 22 accessed through one or more terminals 24. The different entities 30 may utilize different interfaces, as discussed above, for accessing the system 20. The business rules 36 enforced by the system 20 can determine the format, functionality, and customizations of a particular interface. For example, an agent 56 that is exclusive to a particular carrier 42 may use an agent interface that is customized to fit the needs and preferences of the particular carrier 42. The agent interface is also the means by which the agent creates, modifies, and deletes business rules 36 under the control of the agent. Corresponding functionality can be provided in the form of a carrier interface, an underwriter interface, a government entity interface, a broker interface, an advisory interface, an insured interface, or an administrator interface. For example, a carrier 42 can use a carrier interface to create, modify, or delete a carrier business rule 36 or an underwriter 44 can use an underwriter interface to create, modify, or delete an underwriter business rule 36.

As illustrated in FIG. 3, the various relevant entities 30 can interact with each other through the system 20 as configured by the business rules 36. Communication can be substantially simultaneous, with parallel communications being sent to multiple entities 30. This can increase the accuracy and timeliness of insurance related processing that typically involves more than one or two relevant entities 30. The highly linear, sequential, manual, and slow approval and confirmation process of the prior art is to be avoided. In a preferred embodiment, interactions between the various entities 30 are as automated as possible, incorporating intelligence technologies as desired.

For example, an agent 56 or broker 48 using the system 20 can initiate a request that the premium for a particular insured 52 be reduced by a particular amount. If the business rules 36 of the particular underwriter 44 and carrier 42 permit such a change, the system 20 can be configured to automatically approve the change. For instance, a change that is less than or equal to a particular percentage of the higher premium value could be automatically approved pending the identity of the entity proposing the change, the identity of the insured 52, the financial value of the aggregate policies purchased by the insured 52, and any other relevant policy characteristic 40 or combination of policy characteristics 40. If automated approval is not appropriate, the business rules 36 of the system 20 can facilitate a process for either obtaining the requiring approvals, or rejecting the approved change in a timely manner with an electronic audit trail being made available to the proposing entity 30. In some business rule 36 contexts, all approvals could require some manual element to them. The business rules 36 and the system 20 can be configured to be as automated and as flexible as desired by the relevant entities 30.

II. Subsystem-level view

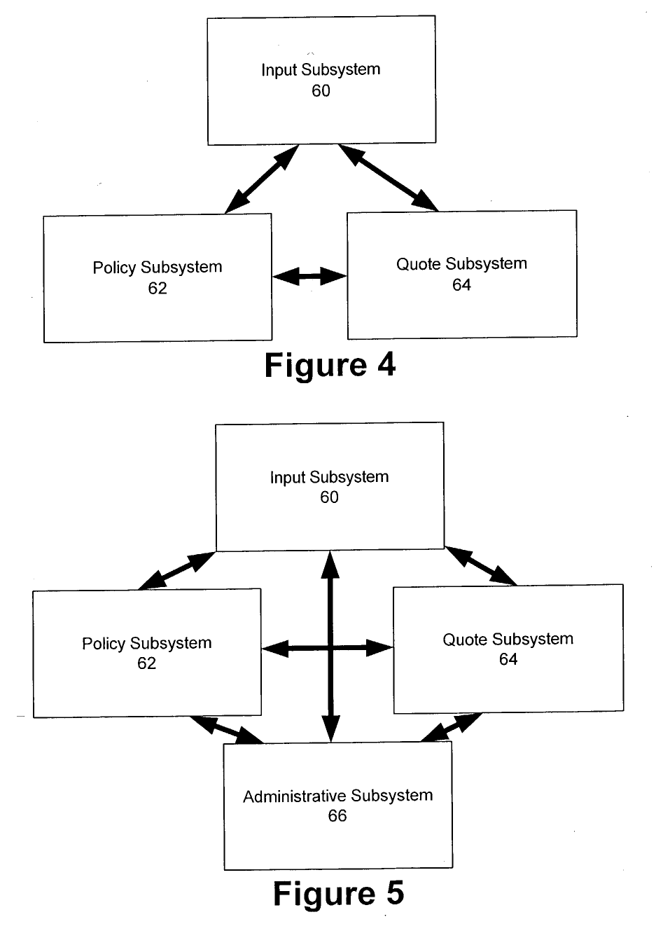

FIG. 4 is a process-flow diagram illustrating one example of a subsystem-level view of the system 20. An input subsystem 60 can capture all inputs to the system 20 by all users 26 and terminals 24. A policy subsystem 62 includes all information relating to insurance policies 28. A quote subsystem 64 is used for generating financial information relating to insurance policies 28. As indicated in the diagram, any of the three subsystems can interact directly with any of the other subsystems.

A. Input Subsystem

The input subsystem 60 can receive or capture inputted data (“input characteristics”) from one or more users 26 using one or more terminals 24. The format of input characteristics can vary as widely as the different types of terminals 24. Thus, input characteristics can be typed text; interactions on a screen, such as a button or list box; clicks of a mouse, light pen, or similar device; recorded oral communication; scanned images; and other forms of data and/or information. The input subsystem 60 can also retrieve policy characteristics 40 from databases and other data storage components utilized by the system 20. Policy characteristics 40 can also be generated from data that is inputted into the input subsystem 60. The input subsystem 60 can automatically invoke business rules 36 to inputs without human intervention, in order to generate policy characteristics 40 from those inputs. Input characteristics can be added (“added input characteristics”); updated (“modified input characteristics”); or deleted (“deleted input characteristics”).

The input subsystem 60 can include terminals 24 at many different locations. If the terminal 24 is at a location that is different than the location of the computer system 22, the location can be said to be a remote client location. For example, remote client locations may interact with the computer system 22 over a network such as the Internet. The input subsystem 60 can be used to receive the inputs required for a pre-filled application. Such inputs can be manually entered into a terminal 24, or read by the system 20 from a file or other form of data transmission.

Input characteristics received by the input subsystem 60 can be relevant even after a policy 28 is created and effective. For example, a subsequent input characteristic can be used to generate a subsequent policy characteristic, a revised policy 28, a revised quote 34 relating to the revised policy 28, and a revised rating 32 relating to the revised policy 28. Subsequent policy characteristics can be modified policy characteristics, added policy characteristics, and deleted policy characteristics. Examples of policy characteristics 40 include a practice location (for a malpractice policy), a mortgagee on property (for property coverage), liability limits, name insured, effective dates for coverage, expiration dates for coverage, umbrella liability limit, premiums, ratings 32, quotes 34, carrier 42, underwriters 44, jurisdictions, brokers 48, administrators 54, and agents 56.

The input subsystem 60 can use a wide variety of different technology mechanisms to facilitate the capture of input characteristics, including chat rooms, instant messaging, e-mail, other Internet-based tools, as well as related to data entry technologies known in the art.

The input subsystem 60 can categorized into various interfaces based on the entity interacting the system 20. For example, the advisory board 50 can use an advisory board interface, agents 56 can use an agent interface, administrators 54 can use an administrator interface, an insured 52 can use an insured interface, brokers 48 can use a broker interface, government entities 46 can use a government interface, underwriters 44 can use an underwriter interface, and carriers 42 can use a carrier interface. The various interfaces can be configured and customized in accordance with the business rules 36.

B. Policy Subsystem

The policy subsystem 62 is typically responsible for maintaining and processing insurance policies 28 and all policy characteristics 40 relating to those policies 28. In some embodiments, the policy subsystem 62 houses the business rules 36 applied by the system 20.

As discussed above, policies 28 can be of a wide range of different types. In some embodiments, the policy 28 is a dentist professional liability policy (“dentist policy”). In some embodiments, the policy 28 can be an integrated dentist policy that includes several distinct policies 28. For example, an integrated dentist policy could include professional liability coverage, general errors and omissions coverage, property and casualty protection coverage (“property coverage”), workers compensation, and other types of policies 28 that would otherwise stand on their own.

The policy subsystem 62 can create a policy 28 from the policy characteristics 40 generated from input characteristics captured from the input subsystem 60. Added input characteristics (described above) from the input subsystem 60 can be used by the policy subsystem 62 to create added policy characteristics. Deleted input characteristics (described above) from the input subsystem 60 can be used by the policy subsystem 62 to delete policy characteristics. Similarly, modified input characteristics (described above) from the input subsystem 60 can be used by the policy subsystem 62 to modify policy characteristics (creating “modified policy characteristics”).

The policy subsystem 62 can include an endorsement module. Such a module can be used to create, modify, or delete standardized endorsements and customized endorsements. Standard and customized endorsements can be renewed or discontinued (suspended) using the policy subsystem 62. The processing of endorsements, and the use of business rules 36 to support endorsement processing in an automated way, is described below. Revised policies 28 can be created with revised endorsements, as defined by revised endorsement characteristics or subsequent policy characteristics. Subsequent policy characteristics can include added policy characteristics, modified policy characteristics, and deleted policy characteristics.

In some embodiments, each policy characteristic is a pre-defined policy characteristic. In other embodiments, both pre-defined policy characteristics and customized policy characteristics can be used by the system 20.

C. Quote Subsystem

The quote subsystem 64 is used to generate financial characteristics (which are a subset of policy characteristics) such as ratings 32 and quotes 34. The quote subsystem 64 can generate financial characteristics for a particular policy 28 from other policy characteristics relating to that that policy 28.

If the system 20 is used to generate a revised policy 28, the quote subsystem 64 can be used to generate revised financial characteristics such as revised ratings 32, revised quotes 34, and other revised financial characteristics.

Any policy characteristic 40 relating to financial attributes or measurements can be defined, generated, and evaluated using the quote subsystem 64. The quote subsystem 64 can be used to generate an analysis of a policy characteristics in accordance with the business rules 36.

D. Administrative Subsystem

FIG. 5 is a process-flow diagram illustrating a different example of a subsystem-level view of the system. FIG. 5 includes an administrative subsystem 66. In many embodiments, the administrative subsystem 66 houses the business rules 36 of the system 20, and the means for adding, updating, and changing business rules 36. In an embodiment of the system 20 where a third party administrator manages the system 20, or where a particular carrier 42, underwriter 44, broker 48, or other relevant entity is responsible for managing the system 20, that managing entity 30 may use a specially configured administrative subsystem 66 for management of the system 20. The business rules 36 for determining how the business rules 36 of different relevant entities 30 can interact with each other can be located in the administrative subsystem 20 for the managing entity.

III. Policy Characteristic and Types of Characteristics

A. Policy Characteristics

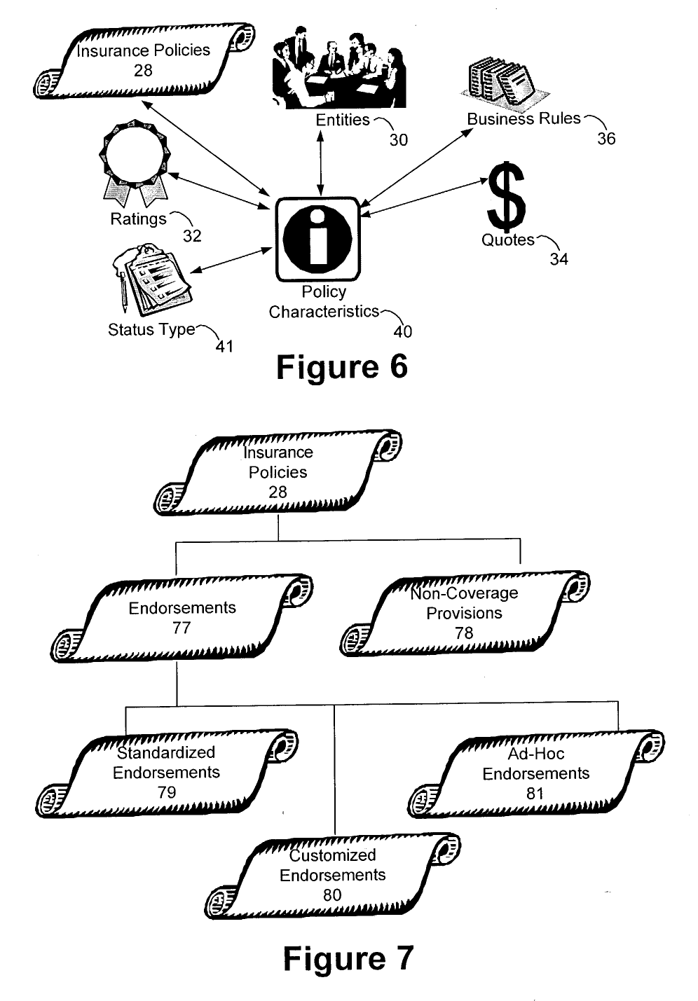

FIG. 6 is a block diagram illustrating some examples of the different types of information that can be processed by the system 20. Policy characteristics 40 processed by the system 20 can relate to a wide variety of potentially relevant information. Policy characteristics 40 can include: financial characteristics, such as ratings 32 and quotes 34; organization-based characteristics such as data relating to entities 30 (“entity characteristics”); status types 41 relating to any type of change or approval processed by the system 20; contract-based information relating to particular policies 28 such as endorsements; and business rules 36 of all types relating to other policy characteristics 40.

B. Types of Characteristics

FIG. 7 is data hierarchy diagram illustrating some examples of different types of policy characteristics 40. Insurance policies 28 can include characteristics which relate to the four corners of the insurance policy (“provision-based characteristics”) and characteristics which constitute policy information 40 but do not relate to a particular contract provision (“non-provision based characteristics”). Entire categories of provision-based characteristics are disclosed in FIG. 7.

Contract provisions can be divided into two categories, provisions relating to coverage (“endorsements”) 77 and provisions that are not related to coverage (“non-coverage provisions”) 78. In many embodiments, endorsements 77 can be divided into potentially three categories of endorsements: form endorsements that could be utilized by multiple entities 30 multiple times (“standardized endorsements” 79); form endorsements that are customized to a particular entity 30, but are not suitable for use with other entities 30 (“customized endorsements” 80); and ad-hoc provisions that are created and used on a one-time only basis (“ad-hoc endorsements” 81).

C. List of Some Standardized Endorsements

User 26 of the system 20 can view a list of existing standardized endorsements 79 in order to determine if new endorsements 77 should be created. Examples of some standardized endorsements 79 that can be incorporated into the system include: policy named insured; mailing address; coverage limits; umbrella coverage limits; policy limits; general liability limits; deductible value; premiums; risk management credit; part time credit; jurisdiction; surge protection; construction code; protection class; building limit; building inflation guard; blanket limit; contents inflation card; valued practice income; mortgagee; loss payee; practice location; property location; additional building equipment; ERISA fiduciary; effective date; expiration date; and any other contract provisions potentially relating to coverage under an insurance policy 28.

The business rules 36 can be configured to permit or preclude changes based on the user 26 entering the proposed change, the entity 30 characteristics relating to the relevant entities 30 involved, the degree of change being proposed, pre-defined numerical ranges or equations in the context of numerical values, other changes made with respect to a particular entity 30, or virtually any other potentially relevant characteristic.

D. Endorsement Characteristics

Standardized endorsements 79 can be created, updated, and deleted by various users 26 in accordance with the business rules 36. Standardized endorsement types exist outside of any particular policy 28 and can possess characteristics beyond those attributes relating to a particular policy 28. Each standardized endorsement 79 can have: a unique database identifier to facilitate the ability of the system 20 to maintain standardized endorsements outside the context of a particular policy 28; a creation date; an author or user 26 responsible for creating the endorsement 77; an endorsement status (“status type” 41); an effective date of the particular change; an expiration date; and certain policy-specific characteristics relating to policy 28 associated with the create/update endorsement request, such as policy number, policy effective date, the name insured, and a general description of the change.

E. Status Types

In a preferred embodiment, as described above, standardized endorsements 79 have a status type (“endorsement status” 41) associated with them. There are a wide variety of different status types 41 that can be incorporated into the system 20. Some embodiments will involve a greater number of status types 41 while other embodiments will utilize fewer status types 41. In a preferred embodiment, the following status types 41 are used:

a. New. An endorsement or endorsement change (collectively, “endorsement”) has been “saved” on the system 20, but not submitted for to a approval.

b. Submitted. An endorsement that has been submitted for approval, but for which no review has yet been conducted.

c. In Process. A submitted endorsement that is currently under review.

d. Suspended. An endorsement in the process of being reviewed by the appropriate personnel, with the reviewer requesting additional information from the requestor.

e. Declined. The endorsement has been declined by the reviewer, with an explanation by the reviewer.

f. Pending. The reviewer (typically a user 26 working on behalf of the underwriter 44) has approved the change, and submitted the change to a different second entity 30 (typically an employee of the carrier 42).

g. Completed. The second reviewer has approved the endorsement, and submitted the endorsement to a proprietary legacy system for incorporation into that system.

h. Waiting Transfer. The endorsement is currently being processed by the legacy system.

i. Completed. The endorsement is fully implemented into the system 20 and is awaiting use, subject to the effective date of the endorsement 77.

IV. Module-Level View

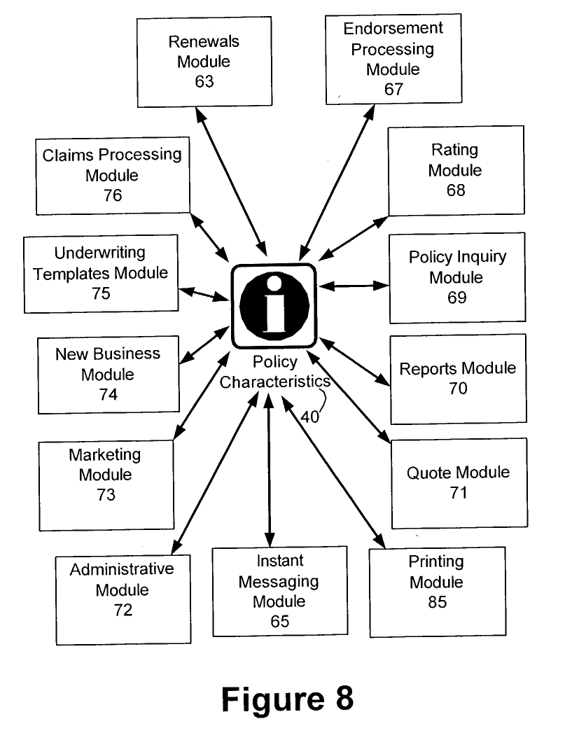

FIG. 8 is a process flow diagram illustrating one example of some of the various modules that can be incorporated into the system 20. Any of the interfaces described above can be used to interface with the modules in FIG. 8, so long as such use is consistent with the business rules 36.

A. Endorsement Processing Module

An endorsement processing module (endorsement module) 67 can be incorporated into the system 20 for any processing relating to contract provisions. Reusable template endorsements (e.g. standard endorsements 79 and customized endorsements 80) as well as one-time only endorsements (e.g. ad hoc endorsements 81) can be created and validated. Endorsements can be created, added, updated, and deleted using the endorsement processing module 67. New or modified endorsements can be automatically validated with regards to business rule 36 compliance. The endorsement processing module 67 can invoke the business rules 36, and identify non-compliant endorsements 77 for the purposes of deletion, or for manual approval by the appropriate relevant entity 30. The endorsement module 67 is typically part of the policy subsystem 62, although it can belong to other subsystems. The endorsement module 67 can include an enhanced underwriting template for building reusable templates from the perspective of underwriters 44. Templates can also be created from the perspective of carriers 42, government agencies 46, brokers 48, advisory boards 50, insureds 52, administrators 54, and agents 56.

The endorsement processing module 67 can also be referred to as a suspend/renew endorsement module 67, whereby endorsements 77 are either renewed or extended pursuant to the input characteristics received through the suspend/renew endorsement module 67. For example, an endorsement relating to flood insurance coverage based on a particular geographic area of property could be renewed or suspended depending on whether or not flood insurance was still required at that particular location. The system 20 can be configured so that an insured 52, an agent 56, a broker 48, an administrator 54, an advisory board 50, a government entity 46, an underwriter 44, a carrier 42, or any other relevant entity 30 could make the system 20 aware of a desired change with respect to flood insurance. The business rules 36 could then either automatically approve the change, automatically deny the change, or subject the proposed change to a manual approval process in accordance with the business rules of the system 20.

In some embodiments, the endorsement business rules are created, housed, and maintained in the endorsement module 67. Policy characteristics 40 that are endorsement characteristics can be pre-defined by users 26 using the endorsement module 67.

B. Rating Module

A rating module 68 can be incorporated into the system 20 for generating, displaying, modifying, reporting, evaluating, and changing ratings 32. The rating module 68 is typically part of the quote subsystem 64, although it can belong to other subsystems. Ratings 32 are the means by which premiums are determined. Ratings 32 can incorporate information relating to the insured 52, categories of data relating to the insured 52, and the nature of the endorsements 77 in the particular policy 28.

Changes in ratings 32 typically result from some other change in a policy characteristic 40. Given a change in risk, an insured 52, some other relevant entity 30, or even the system 20 itself might request the creation of a new rating 32 by the rating module 68. For example, if a medical practice is no longer performing a particular type of risky procedure, the rating 68 for malpractice coverage might improve as a result. The business rules 36 accessed by the rating module 68 can provide for automating rating adjustments in certain contexts while requiring manual calculation or approval in other contexts. All sorts of different policy characteristics can factor in to the rating calculation performed by the rating module 68 and the business rules 36 used to define such calculations. The rating module 68 can be incorporated into either the policy subsystem 62 or the quote subsystem 64 as described above.

In some embodiments, the rating business rules are created, housed, and maintained in the rating module 68.

C. Policy Inquiry Module

A policy inquiry module 69 can be used by the system 20 to perform data inquiries from users 26 and from automated sources, such as the system 20 generating an automated report in accordance with a pre-defined business rule 36. The policy inquiry module 69 is typically part of the policy subsystem 62, although other subsystems can house the policy inquiry module 69. The policy inquiry module 69 can allow any of the relevant entities 30 to access relevant information, such as policy characteristics 40 in accordance with the business rules 36. The policy inquiry module 69 can include an online user manual to provide users 26 with instructions relating to use of the system 20, as configured for that particular user 26. The policy inquiry module 69 can also be used to generate a binder or certificate of insurance or some other proof of insurance (collectively, a “certificate”) from any terminal 24 with access to the computer system 22.

Different entities 30 and different users 26 within those entities can have different authorization levels in accordance with the business rules 36, to access policy characteristics 40 using the policy inquiry module 69. All sorts of different endorsement characteristics, non-endorsement characteristics, and other policy characteristics can be viewed using the policy inquiry module 69. In some embodiments of the system 20, entities can link to detailed information relating to other relevant entities 30 and potentially the business rules 30 of those entities to determine the policies of such entities 30. The policy inquiry module 69 can be incorporated into either the input subsystem 60 or policy subsystem 62 as described above. In some embodiments, inquiry business rules are created, housed, and maintained in the policy inquiry module 69.

D. Reports Module

A reports module 70 can be used by users 26 to create different types of reports 38 such as standard reports (reports that are reused by multiple entities 30), customized reports (reports that are reused for a single entity 30), and ad hoc reports (reports that are created for a one-time basis). The reports module 70 is typically housed within either the policy subsystem 62 or the quote subsystem 64, but can also be housed within the input subsystem 60 or administrative subsystem 66.

Business rules 36 can be configured to determine the types of information in particular reports 38, particular recipients of particular reports 38, the periods of time for which reports 38 are generated, relevant criteria identified in particular reports 38, and other functions.

Different entities 30 can use the business rules 36 of the system 20 to configure the reports module 70 on an entity 30 by entity 30 basis. In some embodiments, bindings and certificates of insurance are created using the reports module 70. The reports module 70 can be incorporated into the policy subsystem 62 as described above. In some embodiments, reporting business rules are created, housed, and maintained in the reports module 70.

E. Quote Module

A quote module 71 can be used by the system 20 for generating, displaying, modifying, reporting, evaluating, and changing quotes 34. Quotes 34 are related to other financial characteristics, such as ratings 32, deductibles, and risk factors, in addition to broader considerations such as aggregate business dealings, intangible benefits, relationship preservation, and other characteristics relating to monetary values (collectively, “financial characteristics”). The quote module 71 is typically housed within the quote subsystem 64, although the module can be located in other subsystems. Online quotes 34 can be generated in real-time by a user 26 having access to the Internet, based on data entered into a web site or from data obtained by the system 20 through other means. For example, the system 20 can be configured to automatically search out relevant information about the potential insured 52 from public and proprietary databases such as those accessible from the Internet.

Just as rating 32 changes are typically caused by a change in some other policy characteristic 40, pricing changes are also triggered by changes in other policy characteristics 40. New quotes 34 can be requested for an existing policy 28 because of a rating change 32, or due to some other change. For example, a portion of real estate covered by property insurance could have been sold by the insured 52. With less property to cover, the insured 52 or some other entity 30 may have requested a new quote 34 for the revised policy. The system 20 can be configured to generate the quote 34 automatically, in accordance with the business rules 36 of the system 20. Quotes 34 can be created for entirely new policies 28 in a similar manner. The business rules 36 can be configured to allow certain pricing factors to be automatically included into a quote 34 (such as property value) while requiring specific approval for other factors (such as a threat by the insured 52 to change policies 28).

The quote module 71 can be incorporated into either the policy subsystem 62 or the quote subsystem 64, as described above. In some embodiments, quote business rules are created, housed, and maintained in the quotes module 71. In some embodiments, the quote module 71 includes functionality relating to the A.M. best rating for a particular carrier 42.

F. Print Module

A printing module (“print module”) 85 can be incorporated into either the administrative subsystem 66 or the policy subsystem 62. The print module 85 allows users 26 to generate formal insurance documents, including but not limited to: policies 28; endorsements 77; certificates of insurance; and other documents involving policy characteristics 40. The print module 85 can potentially be accessed by any type of terminal 24. Thus, the need for physically transporting such documentation can thus be eliminated, saving both time and money. The entities 30 in need of documentation can interact with the system 20, and print out the document for themselves. This functionality is performed in accordance with the business rules 36.

G. Instant Messaging Module

An instant messaging module 65 can be incorporated into the input subsystem 60. The instant messaging module 65 provides a means for the various entities 30 to communicate with each other using the system 20. The business rules 36 can embody the types of information that are exchanged using the instant messaging module 65. The ability to instant message other entities 30 provides an enhanced integrative environment for which to manage insurance contracts.

H. Administrative Module

An administrative module 72 can perform the functions described above of the administrative subsystem 66. Business rules 36 can be created, updated, and deleted. Endorsements 77, reports 38, and other standardized processes can be configured for various groups of users 26 or entities 30. The administrative module 72 is typically housed within the administrative subsystem 68. Processing authority can be set at the state administrator level for a carrier 42, or at other levels of employee or agent authority. The administrative module 72 can be part of the administrative subsystem 66, or it can have its functionality divided up amongst the various modules in FIG. 8. The ability of a particular user 26 to modify or access the business rules 36, can itself be determined by the business rules 36.

I. Marketing Module

A marketing module 73 represents the first introductory face of the system 20 and a potential insurance contract 28 with the potential insured 52. The marketing module 73 is a means for various entities 30 to provide marketing information to each other. Underwriters 44 can market their products to carriers 42. Carriers 42 can market their products to insureds 52. Administrators 54 can market their services to carriers 42 and underwriters 44. Any form of marketing that can be performed through access to one or more terminals can be incorporated into the marketing module 73. Information relating to the various entities, including particular business rules 36 and practices, can be used to market the products and services of an entity. The marketing module 73 can also be used to automatically generate and transmit template communications, such as e-mails, letters, electronic pages, facsimiles, and other communication records in accordance with the business rules 36.

The second part of that process is performed by a new business module 74. In many embodiments, data obtained by the marketing module 73 can be used to provide insurance application data for the new business module 74. The marketing module 73 can also interface with the quote module 71, the rating module 68, and other modules and subsystems used by the system 20.

J. New Business Module

A new business module 74 can be used to generate insurance policies 28 for potential insureds 52 without current insurance contracts 28. “Smart” applications can be filled out online, or pre-filled out applications can be generated using information captured by the system 20 through automated means such as web site search engines and public and private data bases. An applicant's response to a question can determine which subsequent questions are asked. Thus, information from the potential insured 52 can be obtained in an efficient manner, in accordance with the business rules 36 defined by the entity 30. Information can also be obtained from non-inputted sources, such as profiles on public and proprietary databases, flat files in industry standard formats (such as those required by the Health Insurance Portability and Accountability Act), template profiles, and other sources. In preferred embodiments, the new business module 74 interacts with the endorsement module 67, the rating module 68, the quote module 71, and other modules with relevant information. The new business module 74 can reside in a wide variety of different subsystems. The new business module 74 is highly adaptable through the use of the highly configurable business rules 36.

K. Templates Module

A distinct underwriting templates module (“templates module”) 75 can be used to perform processing identified above under the endorsement processing module 67. Underwriters 42 play an important third-wheel role in many insurance contracts 28 that exist between carriers 42 and insureds 52. The templates module 74 provides underwriters 42 with an important way to set business rules 36 that are appropriately set by the underwriters 42 (“underwriter business rules”). The templates module 74 can also provide users 26 with a useful way to interact with the impact of certain endorsements 77 and business rules relating to other entities 30. Underwriter templates define the scope of permitted endorsements 77, ratings 32, quotes 34, status types 41, and other policy characteristics 40. In a typical insurance contract, it is the underwriter 44 that typically exerts the greatest influence on a policy 28, with carriers 42 running a close second. Thus, the ability of underwriters 44 to create, modify, and delete underwriting templates using the template module 75 is an important part of the insurance management process. The underwriter template limits what other business rules 36 can be set by other relevant entities 30 with respect to particular policies 28. The templates module 75 can reside within the endorsement module 67, the policy subsystem 62, or in some other configuration within the system 20.

L. Claims Processing Module

A claims processing module (“claims module”) 76 can be used to process claims by insured 52 in an online or more traditional paper manner.

Pre-approvals can be provided online for certain types of claims, as defined by the business rules 36. For example, certain types of claims that are historically subject to higher rates of fraud can be identified by the system 20 for manual review, while other types of claims that extremely unlikely to constitute fraud can be automatically approved by the system 20 in accordance with the business rules 36. Similarly, claims of relatively high value can be subjected to additional approvals and review, with lesser claims being processing exclusively or almost exclusively in an automated fashion.

In some embodiments, claims are paid online, through means such as PAYPAL, direct wire transfers, or credit card transactions. Claims processing functionality can be performed in an automated fashion, in accordance with the business rules 36. In some embodiments, business rules 36 relating to claims processing (“claims processing business rules”) can be created, modified, and deleted using the claims module 76. The claims module 76 can be located within the policy subsystem 62 or can be embodied in some other configuration within the system 20.

M. Renewals Module

A renewals module 63 can be included in the policy subsystem 62, and should be able to interface directly with the quote subsystem 64. The renewals module 63 allows for the automation of the renewal process, so long as in accordance with the applicable business rules 36. The business rules 36 can determine which renewals can be automatically approved based on the various criteria defined in the business rules 36.

V. Data-Relationship View

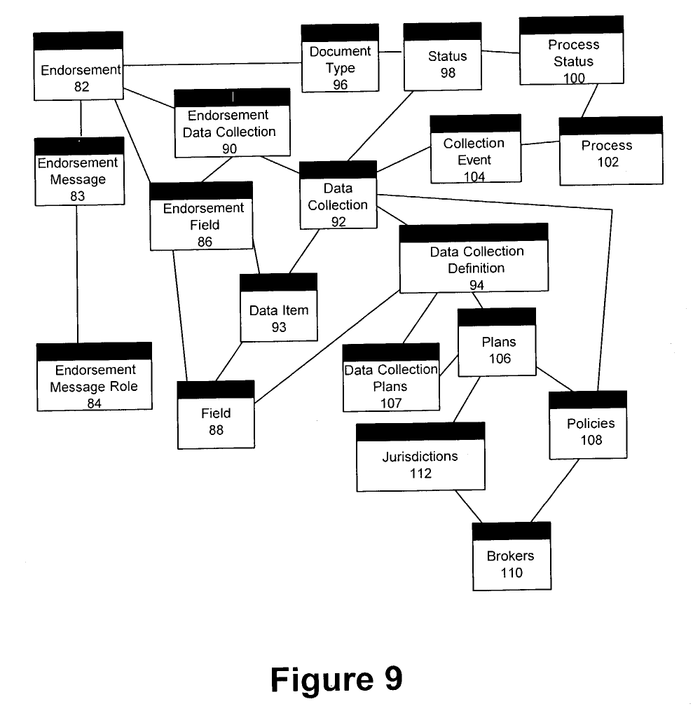

FIG. 9 is a data diagram illustrating the one example of the potential relationships between endorsements 77, various business processes as controlled by the business rules 36, and insurance policies 28. In a preferred embodiment, a fully normalized database structure is used to maximize the ability of the business rules 36 to make highly subtle distinctions between various policy characteristics 40. In a preferred embodiment, an object-oriented programming language is used to house the logic performed by the system 20. In such embodiments, there will usually be a close relationship between the software objects used by the system 20 and the database tables as illustrated in FIG. 9.

The system 20 can be embodied in a wide variety of different data designs, and FIG. 9 is merely illustrative of one such design. The example in FIG. 9 is of a system 20 that interfaces with one or more legacy components. Legacy components are one or more information technology systems used to by users 26 in the insurance industry to store and process information. Thus, the system 20 needs to be able to exchange data with the legacy component. A data item table 93, and other related tables can be an important part of this process.

A. Exchanging Data with Legacy Components

A data collection table 92, a data item table 93, a data collection definition table 94, and a field table 88 can be used by the system 20 to import data from one or more legacy components. Thus, these tables can allow the system 20 to “reproduce” an extra copy of legacy component data within the system 20 itself. These tables form the center portion of diagram. Changes made on the “system” version of this data can then be exported to the legacy component(s) in either a batch or real time manner.

The data collection table 92 stores a “logical” or de-normalized view of policy information include collections or combinations of fields found in the field table 88. The system uses the data collection table 92 to receive data from the legacy components. The data collection table 92 is filled with the logical data of the legacy component. The data collection definition table 94 stores what can be referred to as the “data definition” of the imported data, such as the table and column definitions in the database(s) used by the legacy component(s). Such information relates to the information stored in the fields table 88. The data item table 93 stores data from the data collection table 92 in a normalized fashion, separating for example, a broker 48 and information relating to the broker 48, from a particular policy 28 (with various policy characteristics 40) that happen to be associated with that broker 48. The field table 88 stores the individual data fields that make up the particular data item. For example, the field table may include a character field of twenty characters to store the last name of the broker 46. A status table 98 relates directly with the data collection table 92. The status table 98 contains information relating to the status of the data collected in the data collection table 92.

B. Events, Processes, and Status

The system 20 can trigger processing as a result of various events. One example of the event-to-process functionality is implemented in the system 20 is through the relationship between a collection event table 104 and a process table 102. A collection event table 104 stores events relating to the data collection process. Data collection events can include the creation, modification, submission, or approval of particular data. Alternative embodiments may use various alternative events. The occurrence of a particular event can trigger a process identified on the process table 102. Each process in the process table 102 can possess a status on a process status table 100. The process status table 100 links the process table 102 with a status table 98. Different embodiments can utilize different numbers of status types. In a preferred embodiment, records in the status table 98 will include the status of new, in process, approved, and a description of the status of collection.

C. Endorsement Table and Related Tables

An endorsement table 82 is an important building block in the system 20. The data stored in the endorsement table 82 is data that describes the change information or endorsement 77. Entries in the endorsement table 82 can be associated with one or more entries in the endorsement message table 83. Endorsement messages are messages to users 26 that relate to various endorsement characteristics such as status 41, a monetary value, an approval, a need for approval, or some other endorsement characteristic. Each record in the endorsement message role table 83 can be affiliated with one or more records on the endorsement message table 84. Message roles relate to the purpose, function, or impact of the message as it relates to the business rules 36 and processing performed by the policy subsystem 62. Endorsement messages can be more than mere communications, and can correlate directly with specific automated activities and responses by the system 20 in accordance with the business rules 36. The endorsement message role can be an input or an output to the business rules 36.

The endorsement table 82 links to a document type table 96 because change information originates in one of various document types. The endorsement table 82 interacts with the data collection process described above through the use of an endorsement data collection table 90 and an endorsement field table 86. The relationship between the endorsement data collection table 90 (logical and de-normalized), the endorsement field table 86 (normalized), and the field table 88 (individual data fields) mirrors the relationship between the data collection table 92 (logical and de-normalized), the data item table 93 (normalized), and the field table 88 (individual data fields). Just as the data collection table 92 described above is used to capture logical and de-normalized data, so is the endorsement data collection table 90. Just as the data item table 93 stores the normalized data of the data collection table 92, the endorsement field table 86 stores normalized data of the endorsement data collection table 90. The individual data field information contained in the field table 88 is used by both the endorsement field table 86 and the data item table 86.

D. Plans and Policies

Information relating to insurance plans and individual policies 28 can be stored respectively in a plan table 106 and a policy table 108. The policy table 108 can interface directly with the data collection table 92. In other embodiments, a policy data collection table is used. The plan table 106 can interact with the data collection process through a data collection plan table 107. In some alternative embodiments, the plan table 106 relates directly with the data collection table 92. Broker information can be stored on a broker table 110. Jurisdiction information can be stored on a jurisdiction table 112. Integrated policies (as described above) are typically defined at both the plan record 106 level and at the various individual policy record 106 levels. Plan records 106 are typically associated with only one or more government jurisdictions, as referenced in a jurisdictions table 112. Similarly, a broker record 110 is typically related to only a subset of all potential jurisdiction records because the licensing of brokers is done on a jurisdiction by jurisdiction basis.

Other embodiments may incorporate a wide variety of different data relationships. Different business rules 36 may use or even require different data relationships. Each embodiment will have different requirements with respect to the complexity of the business rules 36, the number and types of entities 30 using the system 20, and other requirements which will dictate the data design used in a particular embodiment of the system 20

VI. Sample Work Flows

A. Process Flow 1

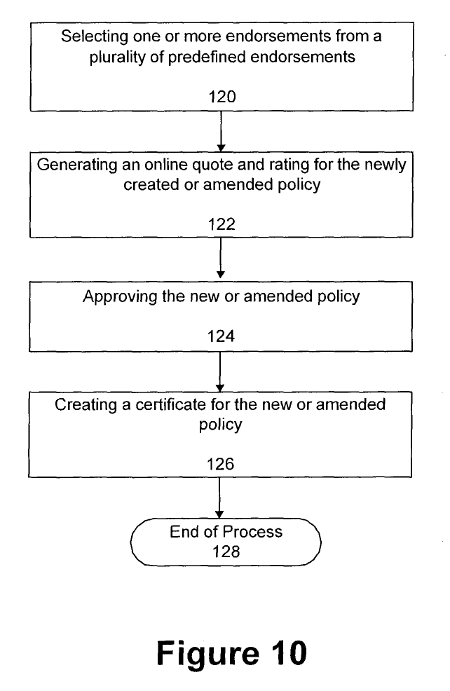

FIG. 10 is a flow chart illustrating one example of a process for creating or modifying insurance policies 28. At 120, the user 26 selects one or more endorsements 77 from a list of pre-defined endorsements 77. In some embodiments, a user 26 may even create new standardized endorsements 79, new customized endorsements 80, or one-time only ad hoc endorsements 81. The selection, identification, or creation of the endorsement 77 at 120 is done in the context of a particular policy 28 or class of policies 28 that needs to either be created or modified in accordance with the business rules 36. For example, at 120, a user 26 of the system 20 could add umbrella liability coverage to two or more distinct policies 28 involving the same insured 52.

At 122, the system 20 can used to generate an online quote 34, a rating 32, and any other policy characteristics 40 for a policy 28, either new or amended, that includes the one or more endorsements identified at 120. The process at 122 can be fully automated, where the business rules 36 are given the role of either approving or rejecting a particular policy 28 based on the endorsements 77 relating to that policy 28. In other embodiments, the business rules 36 are used to automatically approve certain endorsements 77, while requiring manual approval for others. In extrapolating forward the example from 120, the business rules 36 could be configured to approve purely formalistic changes such as umbrella liability that is no greater than the sum of existing policies 28, while invoking a “manual” approval process using the various communication technologies of the system 20, that involve actual increases in liability coverage. In other embodiments, increases in coverage could automatically be allowed, conditioned upon the insured 52 meeting certain financial and historical requirements. The number of potential conditions that can be used by the business rules 36 of the system 20 is limited only by the type of information tracked by the system 20.

At 124, the newly created or modified endorsement 77 can be automatically approved, automatically rejected, subject to a follow-up approval process that is automatically invoked by the system 20, or otherwise responded to by the system 20 in the form some other outcome (collectively, a “determination”). If the end result of the process at 124 is an approval, a certificate of insurance can be created at 126 from any number of terminal 24 locations. If the end result of the process at 124 is not an approval, the process proceeds directly to an end of process at 128. Otherwise, the approved changes or addition is saved on the system 20 before the end of process at 128.

B. Process Flow 2

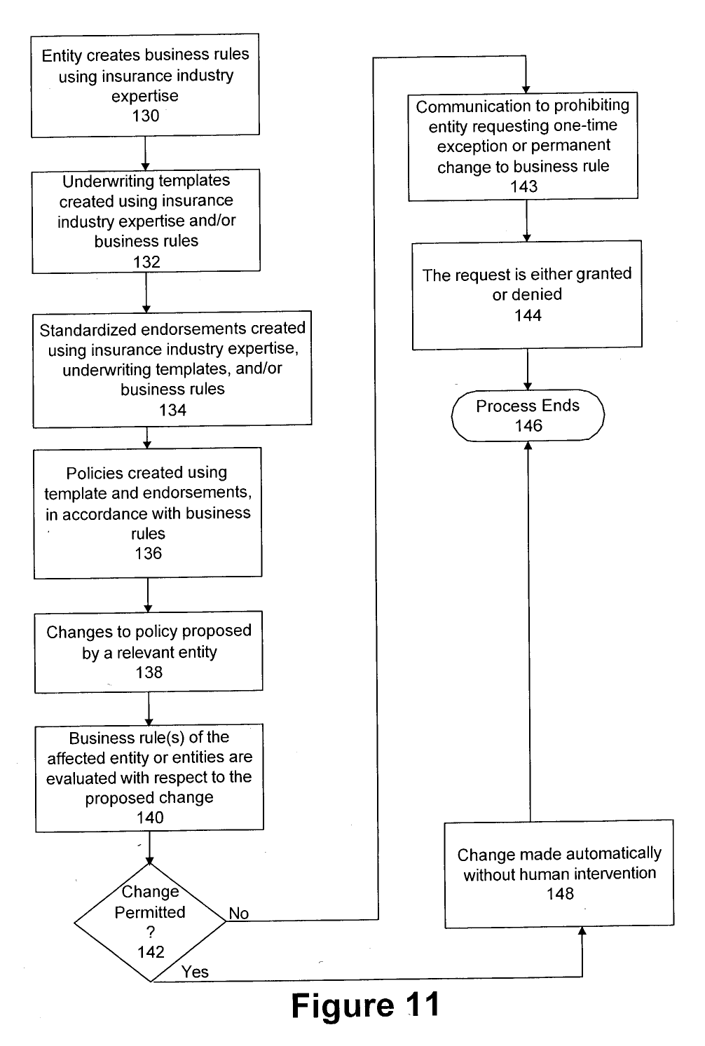

FIG. 11 is a flow chart illustrating another example of a process for creating and applying business rules 36. At 130, a user 26 affiliated with an entity 30 creates business rules 36 for that particular entity 30 using insurance industry expertise. Distinctions based on policy characteristics 40 such as entity characteristics, endorsement characteristics, financial characteristics (such as quotes 34 and ratings 32), and other characteristics can be used by the system 20 to distinguish between different factual scenarios. For example, the business rules 36 at 130 can be configured to distinguish between long-standing customers versus more recent customers; large consumers of insurance coverage versus relatively low consumers of coverage; integrated policies versus individual policies; premiums over a certain amount versus premiums below a certain amount; malpractice coverage versus real property coverage; or any other relevant distinction useful in managing an insurance policy 28. In some embodiments, any entity 30 can create business rules 36. However, the two most prominent and important examples of business rules 36 are typically underwriter business rules and carrier business rules. It is the underwriter 44 and the carrier 42 that make most of the decisions regarding types of coverage and policies 32 that will used. Underwriters 44 can use an underwriter interface to create underwriter business rules. Carriers 42 can use a carrier interface to create carrier business rules.

At 132, the underwriter 44 can use the underwriter interface to create one or more underwriter templates. Underwriter templates can be created using insurance industry expertise, the business rules 36 created at 130, or both. Underwriter templates are a specific category of underwriter business rules that relate to the creation or modification of insurance policies 28. Underwriter templates contain the parameters of policy characteristics that are acceptable to the underwriter 44. For example, the underwriter 44 could determine that only certain ratings 32 are deserving of a policy 38, or that no policy 28 should have a liability coverage that exceeds a certain money value. The underwriter template at 132 serves as the framework for subsequent policy 28 definitions.

At 134, standardized endorsements 79 are created using insurance industry expertise, the underwriting templates, the business rules 36, or some combination of those sources. As discussed above, pre-approved and pre-defined endorsements 77 can be used to quickly put together an insurance policy 28 or to amend an insurance policy 28 in an automated and approved fashion, avoiding errors, delays, and expense.

At 136, policies 28 can be created in a pre-approved manner using the business rules 36 created at 130, the underwriting template created at 132, and the endorsements 77 created at 134. At 138, modifications can be proposed by a relevant entity 30, such as an insured 52 wishing to increase liability coverage, or an administrator 54 wishing to add flood insurance coverage to a policy 28. At 140, the system 20 applies the appropriate business rules 36 with respect to the proposed change. At 142, the system 20 determines whether the particular change is permitted in an automated fashion. If the change can be approved in an automated fashion, at 148 the system 20 can automatically implement the change without human intervention. The business rules 36 of the system 20 may automatically notify certain parties if the change is considered significant by those business rules 36, or such changes can become part of a periodic report that is generated at a predetermined time.

If the change is not permitted at 142, a communication at 143 can be generated and transmitted to an approver designated by the business rule 36. Thus, even in circumstances where approval cannot be automatically implemented, the system 20 can facilitate communication with the approver or approvers. The business rules 36 can include a checklist for various approval processes, with more extreme changes requiring more or higher level approvals. Ultimately the request is either approved or denied at 144, in which case the change is either implemented or not implemented at 144. The process can then end at 146.

C. Process Flow 3

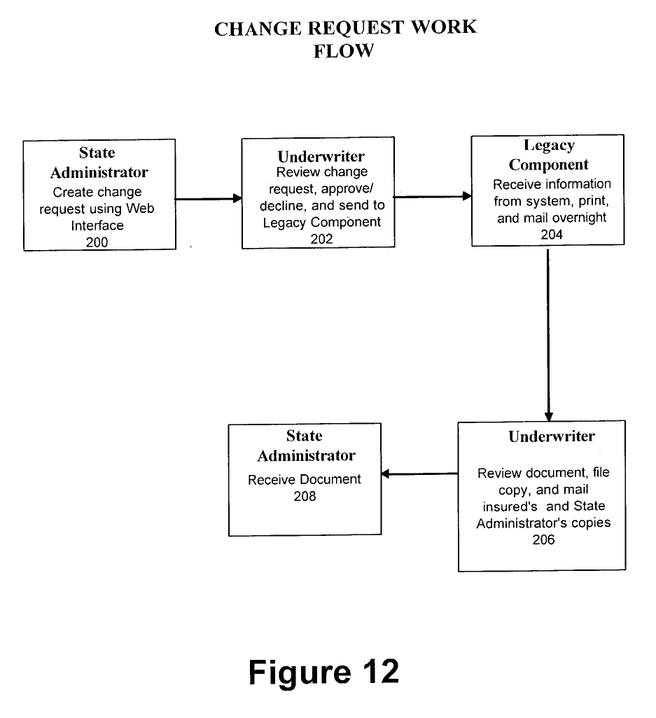

FIG. 12 is a high level flow chart illustrating an example of an endorsement change request being processed in a non-automated manner. The particular embodiment illustrated in FIG. 12 includes a legacy component, insurance management software that is integrated with the system 20. Such embodiments can be desirable because considerable data already exists on such legacy components.

At 200, a state administrator 54 for the carrier 42 creates a change request relating to an endorsement 77. The state administrator 54 works on behalf of the carrier 42, and is responsible for the policies of the carrier 42 within the particular jurisdiction or state.

The underwriter 44 can review the change request at 202, either approving or declining the request, identifying the decision-maker, identifying the rationale, and sending the relevant data to the legacy component. The legacy component is a non-integrated legacy system used by entities 30 such as underwriters 44 and carriers 42 that stores policy characteristics 40 in a non-integrated manner with respect to other entities 30, and does not provide the business rules 36 functionality for intelligent processing. In some embodiments, the system 20 interfaces with such legacy systems so that the functionality of such systems is does not need to be recreated within the system 20.

At 204, for embodiments involving a legacy component, the legacy component of the carrier 42 can receive information from the system 20, and transmit the information back to the underwriter 44. This is to allow the underwriter 44 to review and approve the documents, to the extent such review and approval are not fully performed in an automated manner by the business rules 36. In some embodiments, this transmission process is done in a fully electronic and automated manner. Moreover, many embodiments of the system 20 do not involve a legacy component, with all data being stored and processed directly by the system 20. In legacy embodiments without full automation, the review and approval process of the underwriter 44 can be done using paper-based processes. The legacy component information can be printed at 204 and mailed (preferably overnight) to the underwriter 44. In a fully automated embodiment the step at 204 is not performed because the underwriter 44 can access the policy characteristics 40 using the system 20 to review the documents and issue approvals.

At 206, the underwriter 44 can review the document, file a copy, and transmit copies to the insured 52, and the state administrator 54. In some embodiments, this process is done online in an automated fashion. For example, the jurisdiction administrator 54 for the particular jurisdiction can print copies of the documents from the system 20 using the print module 85 after the approval process has occurred solely within the confines of the system 20. In fully automated embodiments, the insured 52 can access the system 20 to view the information, or the information or documentation can be e-mailed to the insured 52 in various formats known in the art. In less automated embodiments, documentation can always be sent in more traditional ways, such as by facsimile or mail (preferably overnight).

At 208, the state administrator 54 can review the results of the change. The process from beginning to end is significantly faster and less prone to error than the prior art. The advantages of the system 20 are particularly dramatic in a fully automated embodiment.

D. Process Flow 4

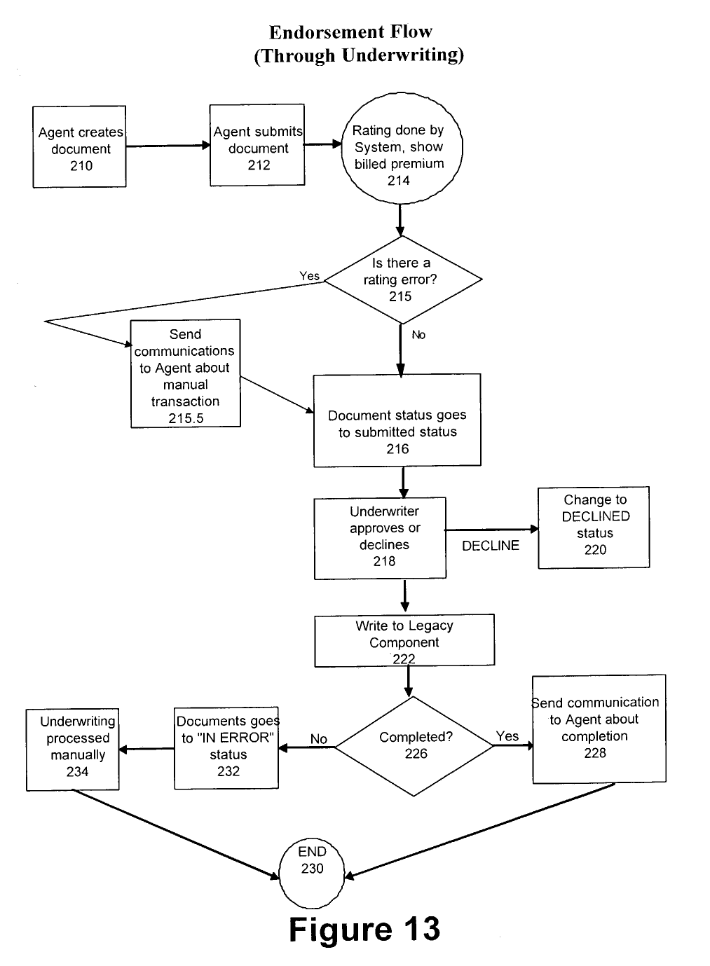

FIG. 13 is a flow chart illustrating one example of an endorsement 77 being submitted by an agent 56 to an underwriter 44 through the system 20. At 210, an agent 56 creates a document containing the proposed endorsement 77. At 212, the agent 56 submits the document to the system 20.

At 214, a rating 32 is generated by the system 20 in order to generate other financial characteristics, including but not limited to a billed premium. The business rules 36 are used to determine the rating, and thus the process for calculating the rating 32 is highly customizable. Ratings 32 can also be automatically evaluated at 214 in accordance with the business rules 36.

At 215, the system 20 determines whether or not the rating 32 created at 214 is acceptable subsequent automated processing, or whether a rating error has occurred, required manually processing. In either scenario, the document can be submitted to the underwriter 44. However, if the rating 32 is unacceptable at 215, the system 20 can be configured to automatically notify the agent 56 about the manual transaction at 215.5.

At 216 a document status can be changed to “submitted.” At 218, the underwriter 44 can either approve or decline the request. This process can be automated or manual, in accordance with the business rules 36 relating to the particular situation. If the document is declined, the status at 220 is changed to “declined” and the process ends. If the document is not declined, the document can be transmitted to the legacy component at 222.

At 226, the system 20 checks to see if the process is completed. If the process is completed, a communication at 228 is sent to the agent 56 relating to the completion, and then the process ends at 230.

If the process is not completed at 226, then some type of error may have occurred, and the status at 232 is changed to “in error.” Communications would have been sent to the agent 56 or other user 26 at 215.5, notifying the relevant personnel of the error, and that the process will need to be performed manually or through the use of the legacy component. Thus, the underwriting process can be performed manually at 234, and then the process can end at 230.

E. Process Flow 5

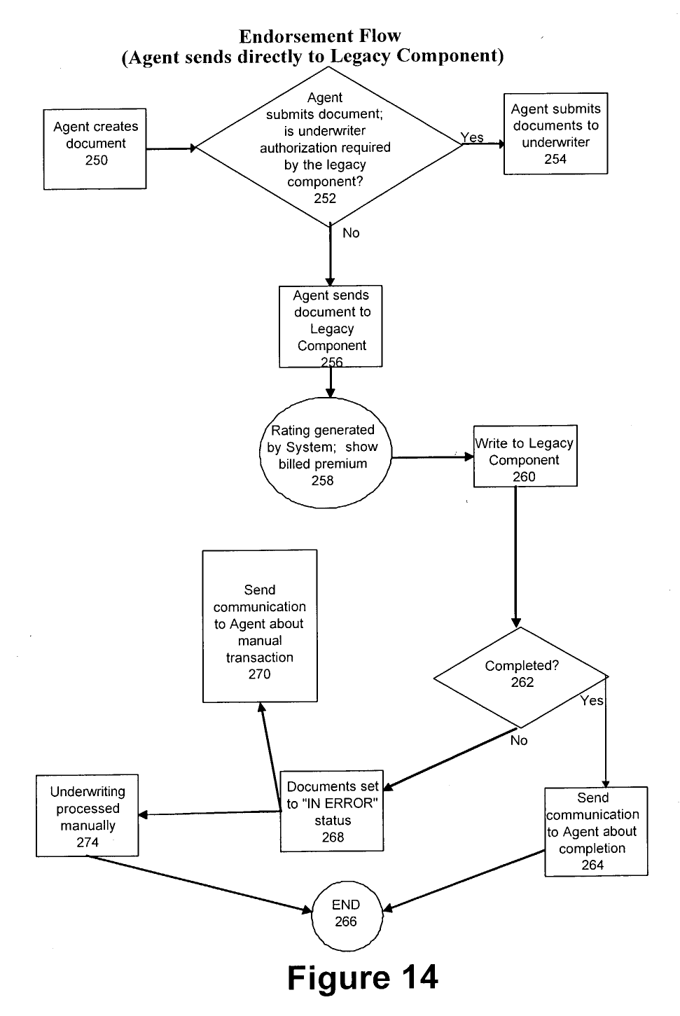

FIG. 14 is a flow chart illustrating one example of an endorsement 77 being submitted by an agent 56 to the system 20 through a legacy component. At 250, the agent 56 creates a document. At 252, the document is submitted to the system 20. The system 20 can determine at 252 whether or not business rules 36 require authorization by the underwriter 44 before the endorsement 77 is submitted to the legacy component.

If authorization of the underwriter is required at 252, the documents can be sent to the underwriter 44 at 254. If authorized by the underwriter 44 at 254, the process can continue with the submission of the documents to the legacy component at 256 as if no underwriter 44 authorization was required. In certain contexts, authorization by the underwriter 44 can be an automated determination performed in accordance with the business rules 36.

If the applicable business rules 36 do not require underwriter 44 authorization for submission of the endorsement 77 to the legacy component, the agent 56 can send the document to the legacy component at 256 through the communication and transmission tools of the system 20. At 258, a rating 32 is generated by the system 20, displaying the billed premium and other financial characteristics. The document can be written in the legacy component at 260. If the system 20 can detect that the legacy component process is completed at 262, a communication can be sent at 264 to the agent 56 and the process ends at 266.

Otherwise, the process is not completed at 262, and an “in error” status attributed to the document(s) at 268. Messages regarding the error can be sent to the agent 56 or other user 26 at 270. The underwriter 44 can then manually process the document at 274 before the process ends at 266.

VII. Alternative Embodiments

In accordance with the provisions of the patent statutes, the principles and modes of operation of this invention have been explained and illustrated in multiple preferred and alternative embodiments. However, it must be understood that this invention may be practiced otherwise than is specifically explained and illustrated without departing from its spirit or scope.

1. An insurance processing system, comprising:
an input subsystem, including an input characteristic and a policy characteristic, wherein said input subsystem provides for generating said policy characteristic from said input characteristic;
a policy subsystem, including a policy, wherein said policy subsystem provides for generating said policy from said policy characteristic; and
a quote subsystem, including a quote, wherein said quote subsystem provides for generating said quote for said policy with said policy characteristic.

2. The system of claim 1, wherein said policy is a professional policy.

3. The system of claim 2, wherein said policy is an integrated professional policy.

4. The system of claim 3, wherein said integrated professional policy comprises a professional liability policy, a general liability policy, a property protection policy, and a workers compensation policy.

5. The system of claim 1, further including a remote client location on a network, wherein said input characteristic is captured at said remote client location on said network.

6. The system of claim 1, further including a subsequent input characteristic, a subsequent policy characteristic, a revised policy and a revised quote;
wherein said input subsystem provides for capturing said subsequent input characteristic and provides for generating said subsequent policy characteristic with said subsequent input characteristic;
wherein said policy subsystem provides for generating said revised policy with said subsequent policy characteristic; and
wherein said quote subsystem provides for generating said revised quote for said revised policy with said subsequent policy characteristic.

7. The system of claim 6, wherein said subsequent input characteristic is a modified input characteristic, and wherein said subsequent policy characteristic is a modified policy characteristic.

8. The system of claim 6, wherein said subsequent input characteristic is an added input characteristic, and wherein said subsequent policy characteristic is an added policy characteristic.

9. The system of claim 6, wherein said subsequent input characteristic is a deleted input characteristic, and wherein said subsequent policy characteristic is a deleted policy characteristic.

10. The system of claim 1, further comprising an administration subsystem, said administration subsystem including a plurality of business rules.

11. The system of claim 10, wherein said plurality of business rules comprise a rating business rule, a policy business rule, an underwriting business rule, and a carrier business rule.

12. The system of claim 10, wherein said administration subsystem provides for adding, modifying, and deleting said plurality of business rules.

13. The system of claim 1, wherein said policy subsystem includes a plurality of policy characteristics, wherein at least one of said policy characteristics is a pre-defined policy characteristic.

14. The system of claim 13, wherein each policy characteristic is a predefined policy characteristic.

15. The system of claim 1, further comprising a pre-filled out application and a business rule, wherein said system generates said pre-filled out application from said input characteristic and from said business rule.

16. The system of claim 1, further comprising a marketing module, a communication, and a business rule, wherein said marketing module automatically generates said communication in accordance with said business rule.

17. The system of claim 1, further comprising a reports module, a business rule, and a report format, wherein said reports module automatically selects said report format in accordance with said business rule.

18. The system of claim 1, further comprising a quotes module, a business rule, and a proposal, wherein said quotes module automatically generates said proposal from said input characteristic with said business rule.

19. The system of claim 1, further comprising a printing module, a business rule, and a certificate, wherein said printing module automatically generates said certificate from said input characteristic using said business rule.

20. The system of claim 1, further comprising a new business module, a business rule, and an approval, wherein said new business module automatically generates said approval with said input characteristic and said business rule.

21. The system of claim 1, further comprising an underwriting module, an underwriting template, and a business rule, wherein said underwriting module automatically modifies said underwriting template with said business rule and said input characteristic.

22. The system of claim 1, further comprising a endorsement processing module, an endorsement decision, and a business rule, wherein said endorsement decision is automatically generated by said endorsement processing module with said business rule and said input characteristic.

23. The system of claim 1, further comprising an instant messaging module and a business rule, a broker, and a carrier, wherein said broker selectively communicates with said carrier in accordance with said business rule using said instant messaging module.

24. An insurance processing system, comprising:
an input subsystem, including a plurality of input characteristics and a plurality of policy characteristics, wherein said input subsystem provides for capturing said plurality of input characteristics and generating said plurality of policy characteristics from said plurality of input characteristics;
a policy subsystem, including a plurality of policies, wherein said policy subsystem provides for generating each policy in said plurality of policies with said policy characteristics relating to said policy;
a quote subsystem, including a plurality of quotes, wherein said quote subsystem provides for generating at least one said quote for each said policy with said policy characteristics relating to said policy; and
an administrative subsystem, including a plurality of business rules, comprising a rating business rule, a policy business rule, an underwriting business rule, and a carrier business rule;
wherein said input subsystem generates said policy characteristics with said plurality of business rules;
wherein said policy subsystem generates said policy with said plurality of business rules; and
wherein said quote subsystem generates said quote with said plurality of business rules.

25. The system of claim 24, wherein said policy is a dentist policy.

26. The system of claim 25, wherein said policy is an integrated dentist policy.

27 The system of claim 26, wherein said integrated dentist policy comprises a professional liability policy, a general liability policy, a property protection policy, and a workers compensation policy.

28. The system of claim 24, further comprising a plurality of predefined endorsements, wherein said input subsystem selectively identifies a predefined endorsement, wherein said policy subsystem generates at least one said policy with said selectively identified endorsement.

29. The system of claim 24, further comprising a pre-filled out application.

30. The system of claim 24, further comprising a claims processing module.

31. The system of claim 24, further comprising an endorsement module for renewing or suspending endorsements.

32. The system of claim 24, further comprising an instant messaging module.

33. The system of claim 24, further comprising an automated underwriting template.

34. The system of claim 24, further comprising an online new business entry screen.

35. A method for creating an insurance contract, comprising:
selecting an endorsement from a plurality of available pre-defined endorsements for an integrated professional policy; and
generating an online quote for the integrated professional policy.

36. The method of claim 35, further comprising identifying a plurality of available pre-defined endorsements in accordance with a plurality of predefined business rules.

37. The method of claim 35, wherein endorsements are selected and online quotes generated by an administrator who is not an employee of a carrier or an underwriter.

38. The method of claim 35, wherein an endorsement is selected to change an existing integrated professional policy.

39. A method for modifying an insurance contract, comprising:
proposing a modification of an endorsement characteristic with an agent interface;
accepting said modification with an underwriter interface; and
updating an underwriter template with the underwriter interface.

40. The method of claim 39, further comprising viewing the proposed modification using an insured interface.

41. The method of claim 39, further comprising creating an analysis relating to said modification with an advisory interface.

42. The method of claim 39, further comprising modifying the endorsement characteristic stored in a legacy component.

43. The method of claim 42, further comprising importing endorsement characteristics located in the legacy component.
